(19) United States
(12) Patent Application Publication
(10) Pub. No.: US 2021/0019837 A1
(43) Pub. Date: Jan. 21, 2021

(54) MULTI-USER AUDIT SYSTEM, METHOD, AND TECHNIQUES

(71) Applicant: Thomas Watson, Seattle, WA (US)

(72) Inventor: Thomas Watson, Seattle, WA (US)

(21) Appl. No.: 16/824,684

(22) Filed: Mar. 19, 2020

Related U.S. Application Data
(60) Provisional application No. 62/874,514, filed on Jul. 16, 2019.

(51) Int. Cl. G06Q 40/00; G06Q 40/02; G06N 20/00; A63F 13/798

(52) U.S. Cl. CPC G06Q 40/12; A63F 13/798; G06N 20/00; G06Q 40/02

(57) ABSTRACT

Methods, systems, and techniques for multi-user audits of assets are provided. Example embodiments provide a Multi-User Audit System (“MUAS”), which enables an asset manager to define an audit, specify the audit criteria, assign one or more data collectors (users) to collect the data. Users are notified and perform data collection, and all users automatically see the combined results in near real time. The MUAS automatically resolves conflicted asset data produced by an audit.

### CROSS-REFERENCE TO RELATED APPLICATIONS

This application claims the benefit of U.S. Provisional Patent Application No. 62/874,514, entitled “MULTI-USER AUDIT SYSTEM, METHODS, AND TECHNIQUES,” filed Jul. 16, 2019, which application is incorporated herein by reference in its entirety.

### TECHNICAL FIELD

The present disclosure relates to methods, techniques, and systems for asset tracking and, in particular, to methods, techniques, and systems for performing multiple user asset auditing.

### BACKGROUND

Typically organizations have a need to track assets such as all equipment governed by an IT (information technology) department. These assets are tracked through their useful lives for numerous reasons including, but not limited to, ensuring that a) assets are returned from departing employees, b) usage of assets are tracked to determine how assets are consumed, c) warranties are optimized to reduce maintenance costs, and d) internal or external audit requirements are satisfied, e) service teams have accurate asset information to resolve incidents quickly.

Audits are typically performed at particular times such as annually. In a large company having a stockroom of thousands of assets this task can be very time consuming since every asset must be physically verified to be in the company's possession (such as by scanning a UPC or bar code label). It is slow and exhausting for a single person to do this, so companies sometimes employ multiple people to perform the physical verification process. In order to be completed in a reasonable amount of time, each of these people may be instructed or agree to perform verification of some set of assets and then the results of each person's work combined manually by a manager and placed, for example, in a spreadsheet or database.

The current audit process by definition is prone to errors. For example:
1) Incorrectly indicating assets as missing: Each user would take a section of the environment and scan assets into a list. They may use a system which indicates whether the asset is expected by the audit, and how many are remaining, but it does not show assets scanned by other users, so there is no way to know as a group if all assets have been scanned. Any expected asset not scanned by a particular user would be determined “Missing,” though another user may have scanned it.
2) Inability to know when audit is done: Since no single user can view the results of all users scanning, there is no way other than through verbal communication to know that everything has been scanned.
3) Errors when compiling of results: The asset manager must retrieve a list of all scans performed by each user, compile them into a list, and perform a comparison against the expected list, all manually.

### BRIEF DESCRIPTION OF THE DRAWINGS

This patent or application file contains at least one drawing executed in color.

Copies of this patent or patent application publication with color drawings will be provided by the Office upon request and payment of the necessary fee

FIG. 1 is an example flow diagram of an overview of the actions to perform a multi-user audit according to an example Multi-User Audit System.

FIG. 2 is a display of a typical user interface screen on a data collector device for auditing assets.

FIG. 3 is an example display of color-coded images used in the multi-user audit process to represent the different state of all of the assets undergoing audit.

FIG. 4 is an example block diagram of a Multi-User Audit System environment.

FIG. 5 is an example block diagram of an example computing system that may be used to practice embodiments of a Multi-User Audit System.

FIG. 6 is an example block diagram of an example data model for implementing an example Multi-User Audit System.

FIG. 7 shows a leaderboard 700 used to enhance scanning interest.

### DETAILED DESCRIPTION

Embodiments described herein provide enhanced computer- and network-based methods, techniques, and systems to automatically coordinate the verification of asset information in an asset database across a given set of criteria (location, stockroom, purchase order, lot, user) with multiple data collectors (including, for example, human beings, robots, etc.). Example embodiments provide a Multi-User Audit System (“MUAS”), which enables an asset manager to define an audit, specify audit criteria, and assign one or more data collectors (users) to collect the data. Users are notified and perform data collection, and all users including the asset manager see the combined results as the audit is progressing.

For the purposes of this description, the following definitions are employed:
An “asset” is a physical object that is owned by a person or organization for a business purpose. It may be used for other purposes (assets in a residential environment, for example).
An “asset database” is an electronic list of assets tracked by an organization for financial, operational, or compliance or other reasons. For example, a list of all IT assets owned by a company stored in a table in an IT asset management software system like SERVICENOW® by ServiceNow.
An “asset manager” is a person responsible for the accuracy of data in the asset database and the processes used to maintain that data.
A “data collector” is a person or machine equivalent who scans assets in a location with a barcode or RFID device to verify the presence of that asset in that location. Alternative ways to verify the presence of an asset, existing or developed in the future are contemplated.
“audit criteria” is the properties of the records in the asset database to be audited, such as a location, an asset type, an assigned user, or any combination thereof. For example, audit criteria can specify that an audit must verify all assets in San Francisco that are of type server, computer, or router.

An organization such as a business entity, company, non-profit organization, team, etc. uses an asset database to ensure all assets purchased are tracked through their useful lives such as to insure that a) assets are returned from departing employees, b) usage of assets are tracked to determine how assets are consumed, c) warranties are optimized to reduce maintenance costs, and d) internal or external audit requirements are satisfied, e) service teams have accurate asset information to resolve incidents quickly.

The organization populates the asset database by entering asset records when they are received from a vendor. This can occur, for example, by scanning assets at a receiving dock. Asset records in the asset database are updated as assets are placed into stock, assigned to users, repaired, returned, retired and disposed. Through these updates, the asset database provides a real-time or near real-time view of everything the organization owns, where it is, and who has it. As used herein, “real-time” or “near real-time” refers to almost real time, near real time, or time that is perceived by a user as substantially simultaneously responsive to activity. Because assets can be stolen or misplaced, and because the processes for updating the asset database may not be followed by employees or otherwise fail, the asset database may be inaccurate.

Use of the MUAS enables the organization to control and track audits in a more accurate way and coordination can be performed automatically by the system itself, without user intervention.

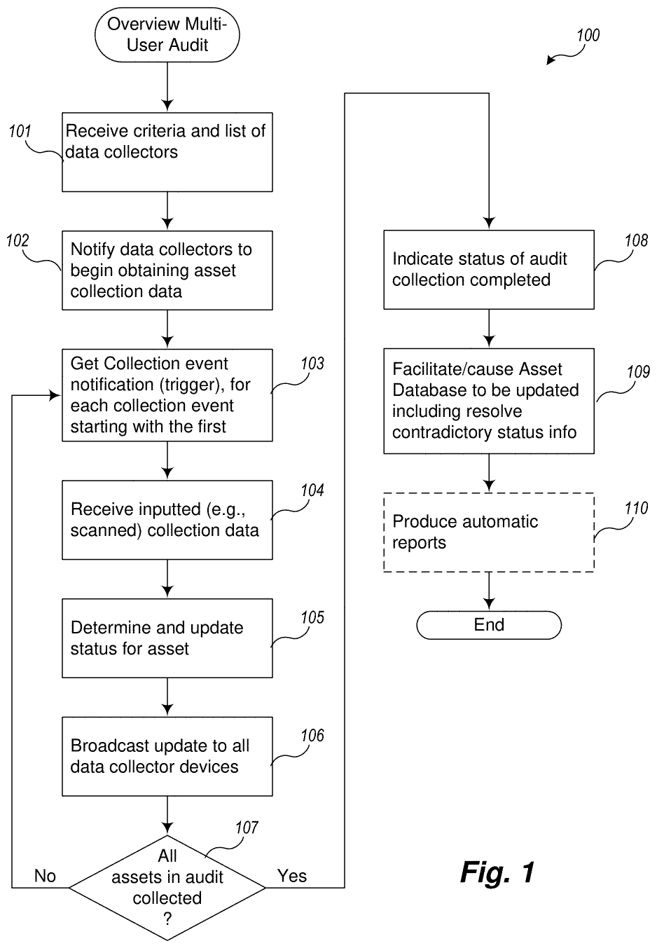

FIG. 1 is an example flow diagram logic of an overview of the actions to perform a multi-user audit according to an example Multi-User Audit System. Logic 100 performs an overview of the multi-user audit process and may be performed by one or more components of a MUAS. In block 101, the MUAS receives an indication of the audit criteria and the data collectors who will be participating in the multi-user audit. In block 102, the MUAS notifies each data collector to begin obtaining asset collection data. Data for an asset may be scanned by any mechanical or electronic means that can be connected to the system, such as for example, using a bar code scanner of 2D or 3D barcodes, a Radio Frequency Identification (RFID) reader, Bluetooth reader, or by an imaging scanner with optical recognition capabilities.

In blocks 103-107, the MUAS loops to process each input (scanned or otherwise inputted) audit event. Specifically, in block 103 the MUAS obtains notification of a collection event. This may be for example, from an SMS or other message notification from a data collector's mobile device. Other means of notification may also be used. In block 104, the MUAS receives inputted collection data from one of the devices of a data collector. In block 105, the MUAS determines the status of the asset based upon the collection data and stores this in a memory area that holds the collection set of asset data to be eventually processed and automatically entered into the asset database. In block 106, the MUAS automatically updates all of the asset collection data being displayed to each of the data collectors so that all of the data collectors have an instantaneous or near real-time updated world view of the audit being performed. This occurs automatically without user intervention. In block 107, the MUAS determines whether all of the assets designated for the audit have been verified (data collected for each one), and, if so, the logic continues to block 108, otherwise loops back to block 103 to process the next collection event.

In block 108, the MUAS indicates to all that the status of the audit collection and verification process is “completed.” In block 109, the MUAS processes each entry of the collected set of asset data against the asset database and enters the appropriate data into the asset database, handling any contradictory status information. For example, new assets may be entered, missing assets are noted or removed, asset data that is changed—example a moved asset—is appropriately updated. For example, a “ghost” asset—which is in the asset database but for which the physical asset is not found, may be removed or noted as missing.

In optional block 109, the MUAS may provide automatic reporting as well.

The following sections describe some details with each of these activities and logic performed by an example MUAS in a typical audit scenario.

### Creating an Audit

To audit an area such as a stockroom, an asset manager creates a new audit record for that stockroom. In a typical example, once the audit criteria is determined, a particular stockroom is chosen from the list of stockrooms. The user interface screen then shows that the asset database expects 5,500 assets in that stockroom. Because that is a lot of assets, the asset manager may want to assign five people to perform that audit. The asset manager then selects five people from a user list, and adds them to the assigned users list for that audit.

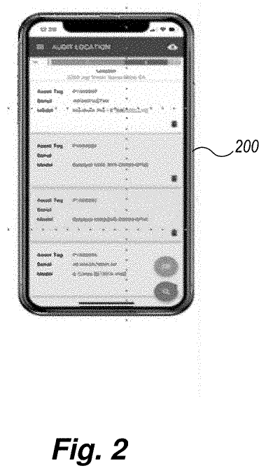

In this scenario, each of the five data collectors runs the MUAS application (client side) which is able to perform an audit. FIG. 2 is a display of a typical user interface screen on a data collector device for auditing assets as described above. Screen 200 can show (not shown) the status of assets being audited (data collected for) by other data collectors as well.

When satisfied with the audit criteria and assignees list, the asset manager uses the MUAS system to “Start” the audit. When the audit is started, a list of assets that meet the audit criteria is populated by the computer software application into an audit table with a “not found” state. Table 1 below shows an example audit table that may be used with the MUAS. This table may be stored as a database as an table of audit data, or integrated into the Asset Table.

TABLE 1

| asset_ id | state | collector | timestamp |
|---|---|---|---|
| Asset 1 | not found | | |
| Asset 2 | not found | | |
| Asset 3 | not found | | |

### Collection the Assets

Each data collector is notified that he/she is assigned to an audit. The data collector can access the multi-user audit system via a mobile or desktop device, and view the audit criteria. The user sees the stockroom to be audited and goes to that stockroom. In some future environments, it may be possible using cameras to “virtually” audit a stockroom without physically going there. This type of virtual audit will operate with a MUAS as described here.

On the data collector device (client application) the data collector sees the list of assets in the audit table. (Optionally, the data collector may only see the number of expected assets that match the audit criteria). The data collector may also see the number of assets in the audit criteria list that a) have been found, b) were scanned that were unexpected, c) are remaining and d) are new/don't exist anywhere in the asset database to begin with.

Each data collector starts scanning assets in the stockroom. As the scanning is performed, if the asset being scanned is in the expected list, the multi-user audit user interface display (the UI) shows the number of “Found” assets incremented by one. This asset record is also visually represented as “Found” by turning the record image from white to green. If the asset is not in the expected list, the UI shows the number of “Unexpected” assets incremented by one. This “Unexpected” asset can also visually represented by changing the color of the record image, for example, from green to yellow. If the asset is new, the UI shows the number of “New” assets incremented by one. This “New” asset can be visually represented by turning the record image from white to red. These color coded images help increase the throughput of asset management processes (reducing labor and labor costs required) including multi-user audit. Other ways to provide “instant” feedback other than color can also be employed, such as through audio or haptic feedback that indicates different statuses of the scanned asset.

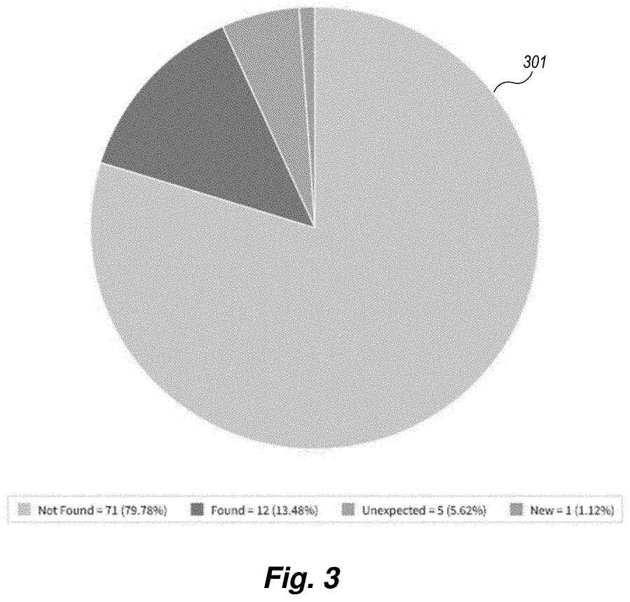

FIG. 3 is an example display of color-coded images used in the multi-user audit process to represent the different state of all of the assets undergoing audit.

### Viewing the “World View” of Inputted Collection Data

As the other users assigned to this audit begin scanning assets (collecting verification data) in the stockroom, each data collector can see each other's respective scans update the audit totals on the user interface. Together, the data collectors automatically act as one (e.g., a single, unified) scanning group, and all the scans are combined into one view shared amongst the data collectors. This is referred to as the world view.

### Completing the Data Collection

When all of the data collectors have completed the data collection verification input process, and believe all assets in the Stockroom have been scanned, each collector can indicate completion. Or, the MUAS can automatically detect the complete status upon detected that all assets have been verified.

### Viewing the Audit Results

When all Data Collectors have completed their data collection, the audit record is updated in the database to a “Data Collection Complete” status. The asset manager then can view the combined results of the audit. Table 2 is a view of the asset table of all assets that were expected, found, not found or new.

TABLE 2

| asset_ id | state | collector | timestamp |
|---|---|---|---|
| Asset 1 | found | torn | 12:45 pm |
| Asset 2 | not found | | |
| Asset 3 | not found | | |
| Asset 4 | new | dan | 12:47 pm |

### Finishing the Audit and Correcting Errors in the Asset Database

When the asset manager is satisfied that all data collection is complete, the asset manager indicates to the system to “finish” the audit. When the audit is finished, the audit record is set to a “Finished” state. This disables the ability for data collectors to further scan (or input verification data by other means) additional assets against those assets.

The MUAS then automatically resolves conflicting information when updating the asset database. Specifically, assets scanned that were “unexpected” are automatically updated in the master asset database, so that the stockroom, location or other audit criteria are applied to the records. This ensures that future reports based on the asset database produce accurate results for those records.

Also, if an asset is discovered in a stockroom but was not expected there, that asset record is updated with that stockroom and set to an “In Stock” state, so that future reporting on that asset database will show the correct asset inventory in that stockroom.

In addition, assets that are missing are set to a “Missing” last audit state or removed, so reports against that stockroom indicate assets that are not likely to be in that stockroom though expected (ghost assets).

### Viewing the Audit Results

When the audit is finished, accuracy is reported, for example, in the form of a percentage of each asset audit state. This report is based on the audit asset table. FIG. 3 shows a pie chart 301 grouping assets that are part of the audit as characterized by the four audit states: found, not found, missing, and new.

### Example Implementation of MUAS

The techniques of MUAS are generally applicable to any type of asset. Also, although the examples described herein often refer to a company, the techniques described herein can also be used by other types of organizations other than business. In addition, the concepts and techniques described are applicable to other assets, including other types of inventory. Essentially, the concepts and techniques described are applicable to any object that is subject to an inventory or audit.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Multi-User Audit System to be used for tracking physical assets such as computer equipment. Other embodiments of the described techniques may be used for other purposes, including to track assets governed by an IT department or equivalent in an organization such as computers, servers, furniture, products, etc. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

In one example embodiment, the Multi-User Audit System comprises one or more functional components/modules that work together to automatically facilitate a multi-user audit with more accuracy and speed. For example, a MUAS may comprise multiple components.

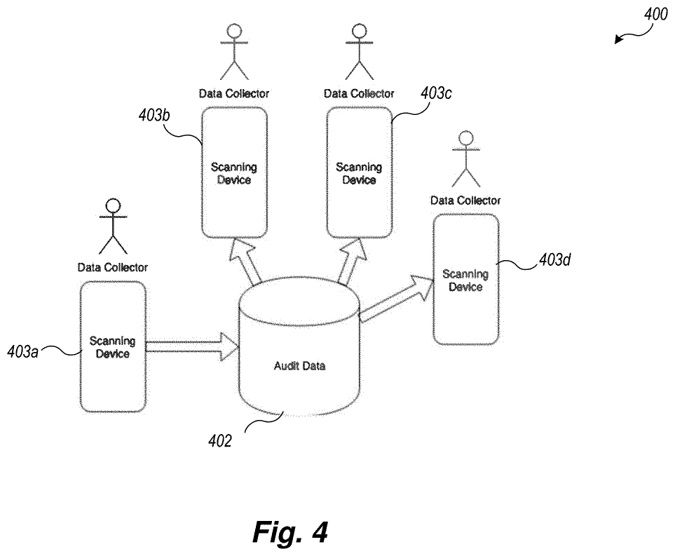

FIG. 4 is an example block diagram of a Multi-User Audit System environment. In FIG. 4, MUAS environment 400 comprises a multi-user audit engine 401, an audit data repository 402, and one or more data collection devices 403a-d, such as scanning devices and the software running on them. Data collector devices 403a-d have a live connection (via the internet, wired, or wireless, via Bluetooth or any other communications protocol) to the server side audit data repository 402, with a communications link (e.g., a network socket) pushing live updates to the audit asset list presented on each connected device 403a-d. In other example MUAS environments, a data collector device may be “offline” and still able to scan data and perform other activities, later uploading any changes and “re-synching” their multi-user audit view when reconnecting to the server side. Other equivalent types of connectivity may be used to communicate from the data collector devices to the audit data store. In some embodiments, the access to the audit data repository 402 is provided via services from a platform such as the SERVICE NOW® platform or is compatible with other asset tracking systems such as that provided by Hewlett-Packard.

FIG. 4 illustrates that as one user scans in data, the other users (data collectors and potentially others) are notified in real time accordingly through updates to their user interfaces. Note that each device is bi-directionally connected through one or more connections.

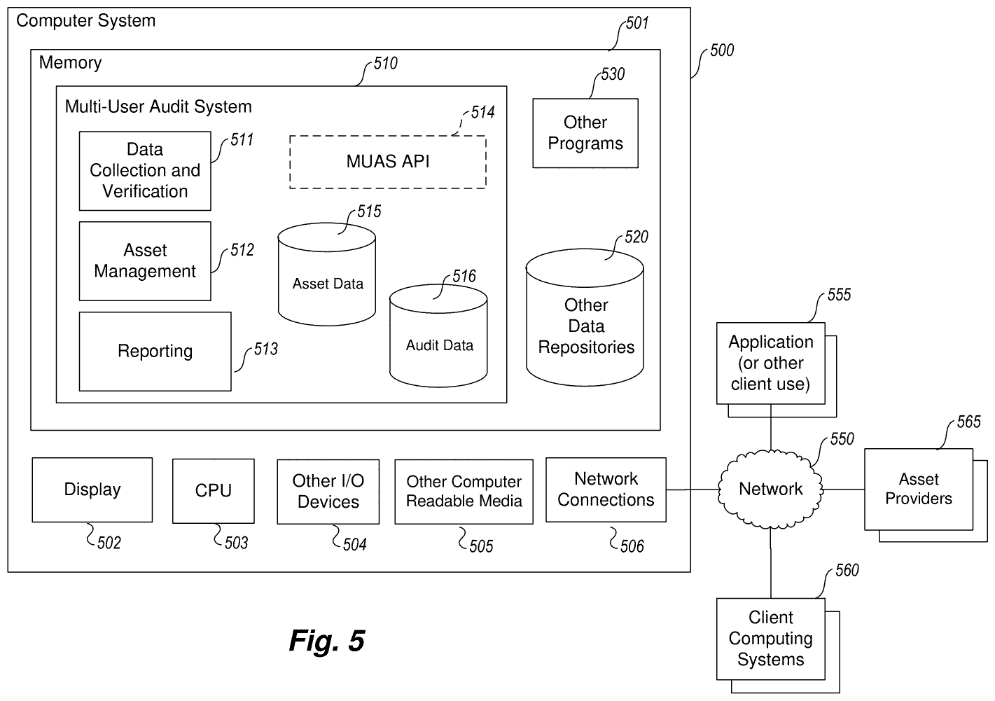

FIG. 5 is an example block diagram of an example computing system that may be used to practice embodiments of a Multi-User Audit System described herein. Note that one or more general purpose virtual or physical computing systems suitably instructed or a special purpose computing system may be used to implement an MUAS. Further, the MUAS may be implemented in software, hardware, firmware, or in some combination to achieve the capabilities described herein.

Note that one or more general purpose or special purpose computing systems/devices may be used to implement the described techniques. However, just because it is possible to implement the MUAS on a general purpose computing system does not mean that the techniques themselves or the operations required to implement the techniques are conventional or well known.

The computing system 500 may comprise one or more server and/or client computing systems and/or services or components and may span distributed locations. In addition, each block shown may represent one or more such blocks as appropriate to a specific embodiment or may be combined with other blocks. Moreover, the various blocks of the MUAS 510 may physically reside on one or more machines, which use standard (e.g., TCP/IP) or proprietary interprocess communication mechanisms to communicate with each other.

In the embodiment shown, computer system 500 comprises a computer memory (“memory”) 501, a display 502, one or more Central Processing Units (“CPU”) 503, Input/Output devices 504 (e.g., keyboard, mouse, CRT or LCD display, etc.), other computer-readable media 505, and one or more network connections 506. The MUAS 510 is shown residing in memory 501. In other embodiments, some portion of the contents, some of, or all of the components of the MUAS 510 may be stored on and/or transmitted over the other computer-readable media 505. The components of the MUAS 510 preferably execute on one or more CPUs 503 and manage the audit of asset data as described herein. Other code or programs 530 and potentially other data repositories, such as data repository 506, also reside in the memory 501, and preferably execute on one or more CPUs 503. Of note, one or more of the components in FIG. 5 may not be present in any specific implementation. For example, some embodiments embedded in other software may not provide means for user input or display.

In a typical embodiment, the MUAS 510 includes one or more data collection and verification logic instances 511, one or more asset management logic instances 512, and reporting component 513. In at least some embodiments, the reporting component 513 is provided external to the MUAS 510 and is available, potentially, over one or more networks 550. Other and/or different modules may be implemented. In addition, the MUAS may interact via a network 550 with application or client code 555 that results computed by the MUAS 510, one or more client computing systems 560, and/or one or more third-party information provider systems 565, such as providers of asset information used in asset data repository 515. Also, of note, the asset data repository 515 and/or the audit data repository (if separate) 516 may be provided external to the MUAS 510 as well, for example in a knowledge base accessible over one or more networks 550.

In an example embodiment, components/modules of the MUAS 510 are implemented using standard programming techniques. For example, the MUAS 510 may be implemented as a “native” executable running on the CPU 103, along with one or more static or dynamic libraries. In other embodiments, the 510 may be implemented as instructions processed by a virtual machine. A range of programming languages known in the art may be employed for implementing such example embodiments, including representative implementations of various programming language paradigms, including but not limited to, object-oriented, functional, scripting, and declarative.

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs, microservice environments, and the like. Some embodiments may execute concurrently and asynchronously and communicate using message passing techniques. Equivalent synchronous embodiments are also supported. Also, other functions could be implemented and/or performed by each component/module, and in different orders, and in different components/modules, yet still achieve the described functions

In addition, programming interfaces 514 to the data stored as part of the MUAS 510 (e.g., in the data repositories 515 and 516) can be available by standard mechanisms such as through C, C++, C#, and Java APIs; libraries for accessing files, databases, or other data repositories; through scripting languages such as XML; or through Web servers, FTP servers, or other types of servers providing access to stored data. The data stores 515 and 516 may be implemented as one or more database systems, file systems, or any other technique for storing such information, or any combination of the above, including implementations using distributed computing techniques. In addition, portions of the MUAS may be implemented as stored procedures, or methods attached to asset data “objects,” although other techniques are equally effective.

Also the example MUAS 510 may be implemented in a distributed environment comprising multiple, even heterogeneous, computer systems and networks. Different configurations and locations of programs and data are contemplated for use with techniques of described herein. In addition, the MUAS components may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an MUAS.

Furthermore, in some embodiments, some or all of the components of the MUAS 510 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

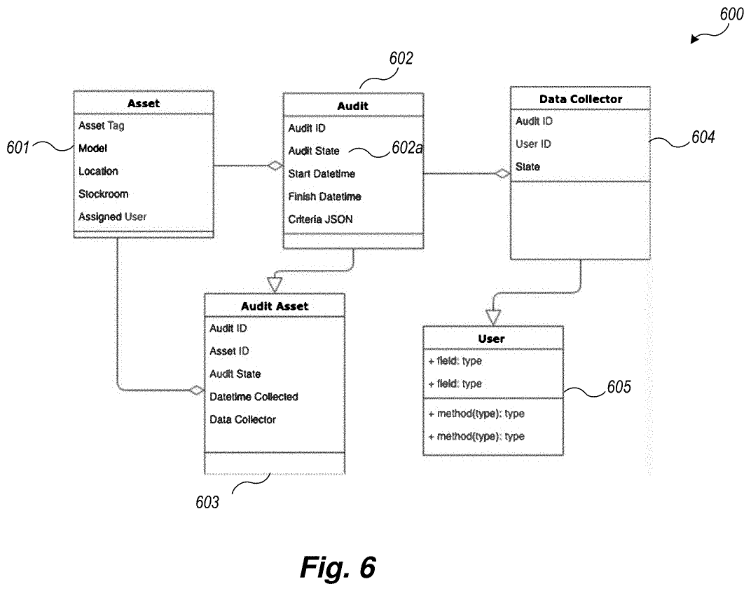

FIG. 6 is an example block diagram of an example data model for implementing an example Multi-User Audit System. For example, this data model may implement data repositories 515 and 516 of FIG. 5. Data Store 600 comprises data for storing audits, the expected audit asset list and assigned data collectors, which are managed in a data store, for example a SQL database using the model shown in FIG. 6. Audits are created and stored in an audit table 602. Expected assets part of the audit are stored in an audit asset table 603. Assigned data collectors are stored in the data collector table 604 and correspond to users table 605. The state of assets captured in an audit is stored in the audit asset table 603.

The audit state field 602a of audit table 602 is used to indicate the state of an asset from asset table 601 in a specific audit. An audit state has four possible values:

Found—An asset that was expected was scanned.

Not Found—An asset that was expected was not scanned and is therefore missing.

Unexpected—An asset was scanned that was not expected in the audit.

New—A new asset was scanned the system has never had a record of before.

### Additional Extensions

Scheduling of Future Audits with Machine Learning:

Using machine learning, the system can track the accuracy of each audit, and schedule future audits more frequently based on audit criteria that produce poor results. For example, if a particular stockroom is audited multiple times, and each time the resulting accuracy is below a certain threshold, the system can automatically schedule more frequent audits to promote greater accuracy. Thresholds can be themselves automatically determined by observations over time and indications from an asset manager than the results are not yet sufficiently accurate.

### Gamification

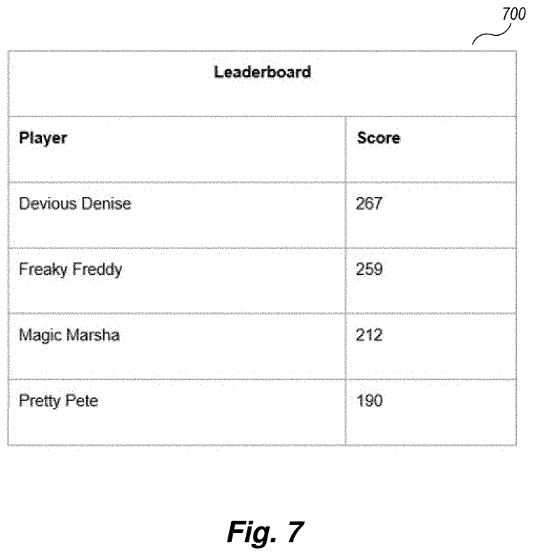

Because scanning assets may be a monotonous task for some users, the system will be enhanced to track the number of scans by each data collector, and to publish a “scoreboard” showing which data collector has scanned the most assets. One or more rewards for different purposes can be given. For example a reward can be given by the asset manager to the data collector that has scanned the most assets. Or for example, rewards may be given for speed or as a result of competitions, and the like. FIG. 7 shows an example leaderboard 700 used to enhance scanning interest. Each user can also upload an avatar of their favorite comic book character and provide a player name. Other similar enhancements are contemplated to increase the gaming experience.

### Value Metering

Combining audit results with Asset value information, the system automatically can report the value of assets lost to the organization. This provides insight into the costs of poor tracking of assets.

Additionally, the system can record baseline time to complete specific tasks without features like multi-user audit and compare this to the time taken to perform tasks using specific features. Applying fully loaded cost for employee time to the time savings a customer enjoys with key features can show the dollar value of labor savings from the specific workflow automation.

### Chain of Custody Reports

Given that the multi-user asset system tracks without user intervention the state of the database as a whole, without requiring the asset manager to manually accumulate the results, the system can potentially be used to automatically produce asset tracking reports that insure chain of custody for legal or regulatory purposes.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 62/874,514, entitled “MULTI-USER AUDIT SYSTEM, METHODS, AND TECHNIQUES,” filed Jul. 16, 2019, is incorporated herein by reference, in its entirety.

From the foregoing it will be appreciated that, although specific embodiments have been described herein for purposes of illustration, various modifications may be made without deviating from the spirit and scope of the invention. For example, the methods and systems for performing multi-user audits discussed herein are applicable to other architectures. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A multi-user audit system for verifying physical assets comprising:
data collection and verification logic configured to:
indicate one or more criteria for conducting an audit by a plurality of data collector users;
distribute indications of a plurality of assets meeting the criteria to each of the plurality of data collector users, at least some of the data collection users responsible for collecting data on a distinct subset of the plurality of assets meeting the criteria;
receive indications of collection events from one or more devices corresponding to each of the plurality of data collector users;
for each received indication of a collection event for a corresponding asset, automatically store corresponding verification data in an asset audit data repository and automatically broadcast a current state of the corresponding asset to all of the plurality of data collector users to enable them in near real-time to observe the current state of all assets undergoing the audit; and
upon completion of a collection event for each asset in the plurality of assets, automatically conclude collection events for the audit and automatically forward indication of completion of collection; and
asset management logic configured to:
receive the indication of completion of collection; and
automatically update assets in an asset data repository corresponding to the verification data for each corresponding asset in the asset audit data repository, while automatically resolving any conflicts between data in the asset audit data repository and data in the asset data repository.

2. The system of claim 1 wherein the asset management logic is further configured to:
automatically resolve conflicts between data in the asset audit data repository and data in the asset data repository by, without user intervention, adding asset data for a new asset to the asset data repository that does not previously exist in the asset data repository, changing asset data in the asset data repository when corresponding asset data for an existing asset in the asset data repository is incorrect; and removing or noting as missing asset data for an asset listed in the asset data repository when no collection data is available.

3. The system of claim 1 wherein the asset management logic does not require an external server beyond that for managing the asset data repository.

4. The system of claim 1, further comprising:
reporting logic, configure to automatically produce audit reports upon completion of an audit.

5. The system of claim 1, further comprising:
competition gaming logic configured to enhance conducting the audit by presenting a leaderboard and facilitating assignment of awards to data collector users based upon audit collection performance.

6. The system of claim 1 wherein a one of the data collection users virtually views assets to collect data on the distinct subset of the plurality of assets assigned to the one of the data collection users.

7. The system of claim 1, further comprising:
forwarding updated asset data repository information to a machine learning engine and automatically scheduling future audits based upon accuracy of past audit performance.

8. A method in a computing system for conducting an audit using a plurality of data collectors, comprising:
receiving audit criteria and list of data collectors;
notifying data collectors to begin obtaining asset collection data for a unique subset of assets matching the received audit criteria;
for each data collection event,
receiving scanned collection data;
determining and updating status for an asset that corresponds to the scanned collection data in an asset audit data store;
automatically broadcasting the status for the asset to all active data collector devices in near real-time; and
upon completion of data collection for all of the assets matching the received audit criteria, automatically indicating a complete status for the audit; and
upon receiving the complete status, facilitating updating of an asset data store with asset audit data including automatically resolving contradictory status information for assets in the asset data store.

9. The method of claim 8 wherein the automatically resolving contradictory status information further comprises:
adding asset data for a new asset to the asset data store that does not previously exist in the asset data store;
changing asset data in the asset data store when corresponding asset data for an existing asset in the asset data store is incorrect; and
removing or indicating as missing asset data for an asset listed in the asset data store when no collection data is available for that asset.

10. The method of claim 9 performed without user intervention so as to maintain chain of custody compliance.

11. The method of claim 8 performed without user intervention so as to maintain chain of custody compliance.

12. The method of claim 8, further comprising:
automatically producing audit reports upon completion of an audit.

13. The method of claim 8, further comprising:
presenting a leaderboard and facilitating assignment of awards to data collector users based upon audit collection performance.

14. The method of claim 8, wherein at least some of the scanned collection data is received from a one of the data collection users that virtually views assets to collect data on the distinct subset of the plurality of assets assigned to the one of the data collection users.

15. The method of claim 8, further comprising:
forwarding updated asset data repository information to a machine learning engine and automatically scheduling future audits based upon accuracy of past audit performance.

16. A non-transitory computer readable storage medium containing instructions to control a computer processor in a server multi-user audit computing system to conduct an audit using a plurality of data collectors, by performing a method comprising:
receiving audit criteria and list of data collectors;
notifying data collectors to begin obtaining asset collection data for a unique subset of assets matching the received audit criteria;
for each data collection event,
receiving scanned collection data;
determining and updating status for an asset that corresponds to the scanned collection data in an asset audit data store;
automatically broadcasting the status for the asset to all active data collector devices in near real-time; and
upon completion of data collection for all of the assets matching the received audit criteria, automatically indicating a complete status for the audit; and
upon receiving the complete status, facilitating updating of an asset data store with asset audit data including automatically resolving contradictory status information for assets in the asset data store.

17. The computer readable memory medium of claim 16, wherein the automatically resolving contradictory status information further comprises:
adding asset data for a new asset to the asset data store that does not previously exist in the asset data store;
changing asset data in the asset data store when corresponding asset data for an existing asset in the asset data store is incorrect; and
removing or noting as missing asset data for an asset listed in the asset data store when no collection data is available for that asset.

18. The computer readable memory medium of claim 16, the method performed without user intervention so as to maintain chain of custody compliance.

19. The computer readable memory medium of claim 16, the method further comprising:
presenting a leaderboard and facilitating assignment of awards to data collector users based upon audit collection performance.

20. The computer readable memory medium of claim 16, the method further comprising:
forwarding updated asset data repository information to a machine learning engine and automatically scheduling future audits based upon accuracy of past audit performance.
